(19) United States
(12) Patent Application Publication
(10) Pub. No.: US 2015/0138303 A1
(43) Pub. Date: May 21, 2015

(54) Eye to Eye Camera Apparatus

(71) Applicant: TelePresence Technologies, LLC, Plano, TX (US)

(72) Inventor: Peter McDuffie White, McKinney, TX (US)

(73) Assignee: TELEPRESENCE TECHNOLOGIES, LLC, Plano, TX (US)

(21) Appl. No.: 14/085,525

(22) Filed: Nov. 20, 2013

(51) Int. Cl. H04N 7/14; H04N 7/15

(52) U.S. Cl. CPC H04N 7/144; H04N 7/15
USPC 348/14.07

(57) ABSTRACT

A camera apparatus with a light-absorbing panel houses a camera facing downwards toward a two-way mirror angled to reflect a view of a user within an observations zone. The camera apparatus is placed on the top of an image display device to cover a computer window displayed on a portion of the image display device. The computer window is used to display a customer transmitted from another location to appear in the line of sight of the user looking through the two-way mirror angled to reflect this line of sight to the camera above. The captured image of the user is transmitted to the location of the customer to appear on an image display system with a perceived eye contact with the customer. A system is disclosed to deliver professional services with eye contact while consummating financial transactions through identification systems and an electronic signature pad.

### TECHNICAL FIELD

The present disclosure relates to video conferencing apparatus and more particularly to apparatus that displays the remote location on a portion of an image display device and transmits the video image of the participant to appear to have a perceived eye contact with a participant at the remote location.

### BACKGROUND

There is a need for a new type of camera apparatus that aligns the camera view with the image of a participant at a remote location displayed on a portion of a screen. There are “teleprompters” that position a camera behind a two-way mirror to align the camera view with a line of sight to a position within a reflected view on a display monitor. While these teleprompters achieve a perceived eye contact as displayed at the receiving location of the transmitted image, these teleprompters are limited to displaying a reflection of the full display monitor.

Traditionally video conferencing has displayed an incoming video of a remote location on the full area of the image display device. If there was a need to display graphic content, the video image of the remote location was replaced with the image of the graphic content. Alternatively, this graphic content was displayed on a second screen. In some cases, one image display device would be used to show the graphic display on one half of the screen and the video conference video on the other half of the screen. None of these display options address a current need to maintain a line of sight to the video conference video for eye contact while providing a portion of the area of the image display monitor for the display of collaborative visual content.

The advancement of numerous applications of web based video using webcams, such as Skype, has achieved a broad adoption of video communication that is displayed within a window on a portion of a computer monitor. Typically a webcam is placed at the top of the computer monitor. In this configuration the camera is viewing downward to the user while the user looks at the image of the remote location on the computer screen. As a result, the webcam captures the image of the user appearing to be looking downward, which is displayed at the remote location with the remote participant not being able to make a perceived eye contact.

There is a need for an eye-to-eye camera apparatus that would overcome the misalignment of eye contact due to the standard camera position of video conference systems.

### PRIOR ART CONFIGURATIONS

The prior art of FIG. 1 illustrates a typical configuration of webcam 2 placed at the top of an image display device 3 with a camera line of sight 5 toward a user 1 and the user's line of sight 6 toward a window for a video image 4. The video window 4 is a small portion of the image area on the image display device 3, which allows the user 1 to see other visual content outside of the video window. In this arrangement the user 1 is close enough to the image display device 3 to touch it if it would be touch sensitive for interaction. In this arrangement it is apparent that the downward angle of view of the camera line of sight 5 does not match the horizontal line of sight 6 of the user 1. As a result, the camera 2 will capture an image of the user 1 appearing to have a downward gaze. This misalignment of the line of sight is undesirable since it does not achieve a perceived eye contact that is an important aspect of face-to-face communication.

Previous configurations have achieved eye contact. The prior art of FIG. 2 illustrates a two-way mirror 9 that is angled so that it reflects a horizontally positioned image display device 3, such as a monitor or screen. The reflected image 10 will appear to be behind the two-way mirror 9. A camera 2 is placed behind the two-way mirror 9 in a position in direction 8 on the eye level of the person displayed on the reflected image 10 of the image display device 3. The area behind the two way mirror 9 is black with the camera surrounded by an opaque enclosure 11 and an overhead black panel 7 so that the camera does not have light reflected on the two-way mirror and the user 1 does not see an illuminated area surrounding the camera 2. This prior art configuration requires a large two way mirror 9 which positions the user 1 a distance away from the reflected image 10. Also, this configuration does not allow the user 1 to reach the reflected image 10 for the potential usage as a touch screen.

The prior art of FIG. 3 shows a configuration where the user 1 views through a two-way mirror 9 to an image display device 3. A camera 2 is positioned below the two way mirror 9 to view upward in the direction 5 for a reflected camera view in the direction 8 at eye level of a user 1. The user 1 has a perceived eye contact when viewing in the line of sight 8 through the two-way mirror 9 toward the image display device 3. A black panel 7 is positioned above the two-way mirror 9 so that the camera view through the two-way mirror 9 does not superimpose any light on the reflected camera view. The camera is surrounded by a black panel 11 so that the user looking at the image display device does not have a visible superimposed image caused by the reflection off the two-way mirror. This prior art embodiment requires a physical size of the black panels 11 and 7 to be approximately equal to the height of the image display device 3. This requires that the user 1 is a distance from the image display device that may be more than the depth of a typical desktop. Furthermore, the image display device is behind the two way mirror 9 which makes it impossible for the user 1 to access potential touch screen functions.

The prior art of FIG. 4 is similar to FIG. 3, except that the camera 2 is positioned above the image display device 3. The same disadvantage of the depth of the system and the lack of access to a touch screen function apply to this configuration.

The prior art of FIG. 5 shows a configuration that achieves eye contact with a person appearing on a small portion of the screen. This prior art configuration has the advantage that it has a reduced physical depth compared to the configurations in FIGS. 1 through 4. Also, the prior art of FIG. 5 allows for access to a large portion of the screen area for touchscreen functions. The eye contact line of sight 8 is between the user 1 and the camera 2 to view an image of a remote person appearing at the position 14. The eye contact image area 14 is above the image display device 3, which may have the disadvantage of requiring the user to look at an angle upward.

At least similar arrangements have been addressed in a publication of the IBM Technical Disclosure Bulletin Vo. 35, No. 2, July 1992, and in U.S. Pat. No. 7,972,006 Giraldo. While these arrangements may achieve eye contact, they require that the user looks upward toward the camera above the monitor, which is unnatural when using a computer monitor the size normally used in professional applications.

The prior art of FIG. 6 is a more detailed view of FIG. 5. The eye contact line of sight 8 views through a small two way mirror 12 to be in line with the camera 2 when viewing the reflected small image area 14. The user 1 views along the eye contact line of sight 8 to see a reflection off the small two way mirror 12 in the direction 17, which views a reflection off a mirror 13 in the direction 18 to see the small image area 4. It is a disadvantage of this prior art that the reflected image area 14 appears a distance behind the image display device 3.

Hence, there is a need for an improved system that addresses the shortcomings of the prior art mentioned above. The problems and needs outlined above may be addressed by preferred embodiments of the present invention.

### BRIEF DESCRIPTION OF THE DRAWINGS

The above features of the present embodiments will be more clearly understood from consideration of the following descriptions in connection with accompanying drawings in which:

FIG. 1 illustrates a prior art configuration of a video conference arrangement with a webcam above a monitor resulting in a misalignment of eye contact;

FIG. 2 illustrates a prior art configuration displaying a reflected image of a person on an image display device with a camera at eye level behind a two way mirror;

FIG. 3 illustrates a prior art configuration displaying a camera viewing toward a two-way mirror to view a reflection of an image of a transmitted person shown on an image display device behind the two way mirror to achieve a perceived eye contact;

FIG. 4 illustrates a prior art configuration as shown in FIG. 3 with the camera positioned above the two-way mirror and the mirror angled to reflect the camera view toward the user;

FIG. 5 illustrates a prior art configuration with a camera positioned above an image display device with a view of a user seen through a two way mirror with the two way mirror angled downward to reflect a view of a reflection off a mirror to view an image displayed on an image display device:

FIG. 6 illustrates a detailed drawing of FIG. 5;

FIG. 7 illustrates a first embodiment of the present invention with a camera facing downward to view a reflection of a user with a line of sight to the image of a transmitted person displayed on an image display device to achieve a perceived eye contact;

FIG. 8 illustrates a drawing of FIG. 7 with the angle of view of a user looking through a two way mirror on an image display device with a reflection of a black panel above;

FIG. 9 illustrates a perspective view of the first embodiment;

FIG. 10 illustrates an arrangement of the first embodiment with a user seated at a table;

FIG. 11 illustrates the display area of an image display device with an upper middle portion of the image area allocated to a small area to be viewed through an embodiment of the invention;

FIG. 12 illustrates a variation of FIG. 11 with the allocated area positioned to the upper left of the image display device;

FIG. 13 illustrates a variation of FIG. 11 with the allocated area comprising a portion of a video image shown on the image display device;

FIG. 14 illustrates an embodiment of the invention with a user positioned close enough to an image display device to reach the screen surface for interacting with a touch screen capability;

FIG. 15 illustrates an embodiment of the invention with the user positioned further away from the image display as shown in FIG. 14 with a camera angle of view to capture the upper body of the user;

FIG. 16 illustrates an embodiment of the invention with the user positioned further away from the image display device as shown in FIG. 15 with a camera angle of view to capture the user from the waist up;

FIG. 17 illustrates a detailed configuration of an embodiment positioned on a monitor;

FIG. 18 illustrates the embodiment as it is ready for packing;

FIG. 19 illustrates the embodiment folded up for shipping.

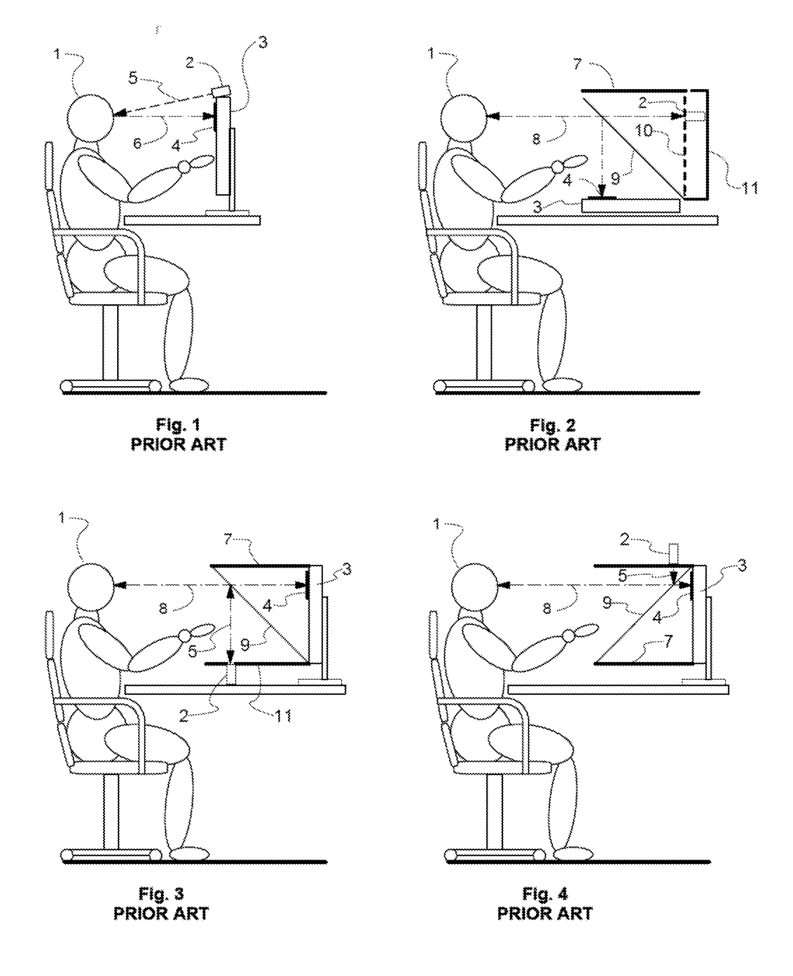

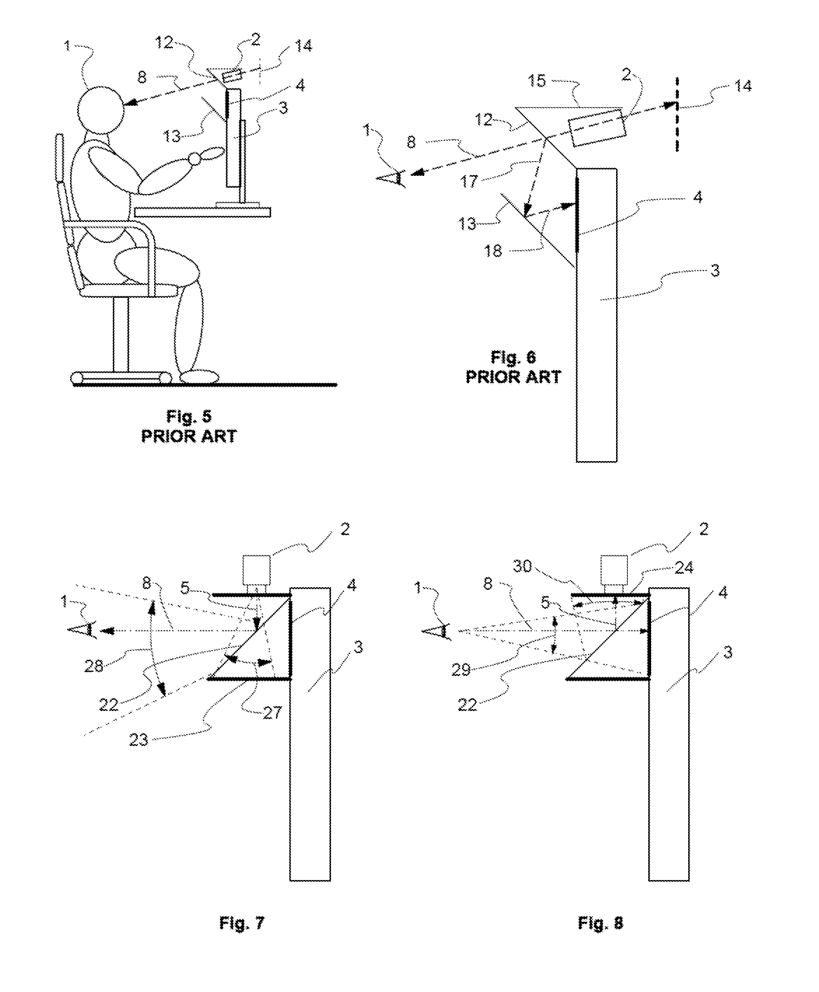

### DETAILED DESCRIPTION OF ILLUSTRATIVE EMBODIMENTS

Referring now to the drawings, wherein like reference numbers are used to designate like elements throughout the various views, several embodiments of the present invention are further described. The figures are not necessarily drawn to scale, and in some instances, the drawings have been exaggerated or simplified for illustrative purposes only. One of ordinary skill in the art will appreciate the many possible applications and variations of the present invention based on the following examples of possible embodiments of the present invention.

FIG. 7 shows an embodiment of the present invention where there is provided a video conference system for allowing a user located in an observation zone to achieve a perceived eye contact in live video communication with a person using a video conference system at another location. The system includes an image display device 3, which may use an LCD, LED, OLED or other display technology capable of displaying video and computer outputs. The image display device 3 may be the screen of a laptop computer, an electronic tablet, a computer monitor, a video monitor, an All-in-One computer or a rear projection screen surface. Commonly available image display devices are thin flat panels with integrated back lighting. As an example, an image display device with a 27″ screen is relatively inexpensive and commonly available while providing enough image area to allocate a portion of the screen for video communication and the rest of the screen for other visual content.

The eye-to-eye camera apparatus uses a small two way mirror 22 to perform the function of transmission of light for the viewing of a portion of the screen area by the user and reflection of light for the camera view along the eye contact line of sight 8. Unlike the two-way mirrors in some of the prior art, this small two-way mirror 22 is a fraction of the width of the image display device 3. As a result the small two-way mirror 22 is also a fraction of the cost of configurations that require the two-way mirror to cover the full area of the image display device. Furthermore, the small two-way mirror 22 has a minimal depth that allows the user 1 to be within reach of the image display device 3.

The small two-way mirror 22 is a partially silvered transparent substrate, which could be glass, plastic, Mylar or other transparent material. There may be a preference for a glass substrate due to the ease of cleaning and durable surface for long term usage with minimal visible wear. A glass two-way mirror may be ⅛″ or 3 mm thick as a commonly available size. A two-way mirror has sometimes been referred to as a one-way mirror or a beamsplitter. The small two-way mirror 22 may have a characteristic of 70% transmission and 30% reflection, which allows more light to pass through the partially silvered transparent substrate to minimize the light loss in viewing a portion of the image 4 on the image display device 3. However, it may be more advantageous to have a characteristic of 50% transmission and 50% reflection to provide more light reflected to the camera 2 from the observation zone of the user 1. The small two-way mirror 22 may be positioned to have the reflective surface of the semi-reflective substrate facing the camera 2 so that the first surface of the camera view is reflective. In addition, the back surface may have an anti-reflective coating to minimize an unwanted secondary reflection.

The apparatus has a camera 2 that captures a live video communication. The camera may be capable of a high definition video, such as 720 or 1080. The camera video output may be an HD standard, such as HDMI, SDI, DVI or other standard. In order to minimize the overall physical size of the eye-to-eye camera apparatus, it may be optimal to specify a camera with a minimal physical size. The camera may be in the form of a block camera with a custom enclosure integrated into the apparatus or may be a compact camera with screw input for mounting to the apparatus. The camera may have a lens mount for C-mount or CS mount lenses to allow for a wide selection of professional lenses. The lens for the camera may have a fixed focal length or may have a manual zoom or automated zoom capability. Another format of the camera 2 may be a webcam with a standard output, such USB2 or USB3.

The apparatus positions the camera 2 above the small two-way mirror 22 for an angle of view 27 toward the two-way mirror 2 for a reflection in an angle of view 28 toward the observation zone with the user 1. The camera 2 has a line of sight 5 toward the small two-way mirror 22 for a reflection of a line of sight 8 that is toward the eye level of the user 1. The downward angle of view 27 will also view through the small two-way mirror 22 to the surface of the panel 23. The panel 23 may have a black surface so that the camera 2 does not have additional light superimposed into the camera image that would detract from the reflected view 28 of the user 1 in the observation zone.

The FIG. 8 is another detailed view of the apparatus showing the angle of view 29 of the user 1 looking through the small two-way mirror 22 toward the live video window 4. The user's angle of view 29 has a reflected view 30 off the small two-way mirror 22, which is toward the panel 24. The panel 24 has a black surface so that the user 1 does not have any additional light superimposed into the reflected view that would detract from the direct view of live video window 4. The panel 24 has an opening for the camera 2 to view through it.

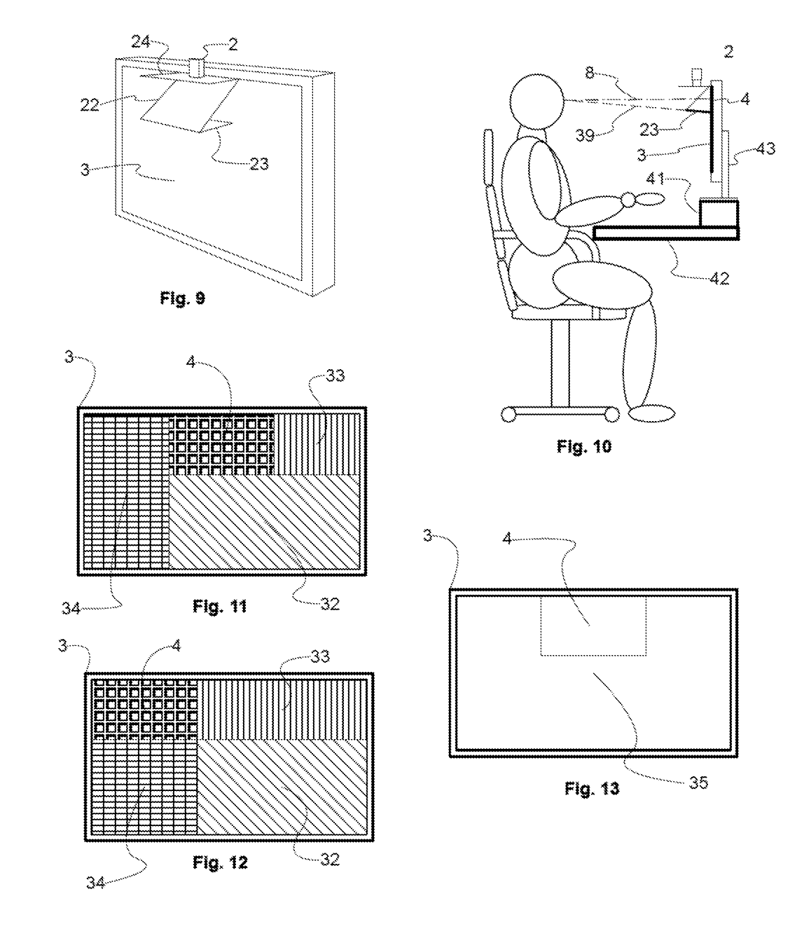

FIG. 9 shows a perspective view of the apparatus. The eye-to-eye camera apparatus comprises a camera 2, overhead black panel 24, small two-way mirror 22 and lower black panel 23 in front of an image display device 3.

FIG. 10 is the apparatus with a user 1 seated at table with a tabletop 42. The image display device 3 has a stand 43, which may be an integrated stand of a typical monitor. Below the image display device 3 with its stand 43 may be a base 41 to raise the video window 4 to the height of the eye level of the user 1 to achieve a horizontal line of sight 8 for eye contact. The base 41 may be comprised on a number of spacers that could be stacked to raise or lower the image display device 3.

The line of sight 39 from the user 1 to the bottom of the video window 4 will be at an angle downward below the horizontal line of sight 8 for eye contact. The lower panel 23 may match the angle of the line of sight 39 so that the user 1 will not have image area below the lower panel 23 blocked from view, which might happen if the lower panel would be horizontal. This configuration of the eye-to-eye camera apparatus provides the direct view of the video window 4 while exposing a substantial area of the image display device 3 to be available for other visual content.

FIG. 11 illustrates an arrangement of the screen area of the image display device 3. The video window 4 may be located in the upper middle portion of the overall screen. A window for user controls 33 could be located to the right of the video window 4. The window for the user controls 33 could include the display of functions for the video communication, such as initiating a call, answering a call, forwarding a call, ending a call and other call management functions. It could also provide information about the operation of the video equipment, such as camera zoom functions, audio level setting, audio and video mute selection, network bandwidth selection, presentation selection, audio and video recording functions, etc.

A window for customer information 34 could be displayed to the left of the video window 4. The window for customer information 34 could include information accessed from a database that was specific to the customer in the location receiving the video conference. The receiving location could have a means for identifying the customer, such as a magnetic card reader. As an example, a banking customer could take a seat at a desk in a branch bank that was equipped with a video conference system with a network connection to an eye-to-eye camera apparatus system at another location. A network connection would be initiated between the banking customer at the branch bank and an agent at another location representing the bank at an eye-to-eye camera apparatus system. The banking customer in the branch bank would swipe their bank card which would initiate access to their bank details to be viewed by the banking agent at their location. This customer information could be clearly viewed by the banking agent by looking at their window for customer information 34 on their screen while viewing the banking customer with eye contact in the video window 4. This method of live video communication would make it possible to have a more personal communication between the banking agent and the banking customer. The eye-to-eye camera apparatus would capture the video image of the banking agent to have a perceived eye contact with the customer, which is a more natural interaction between people. Even though the eye-to-eye camera apparatus is a physically small device, the quality of the image could be high definition and could be displayed at the customer location for the banking agent to appear life-size and could appear to be three dimensional with systems covered by patents and applications by White, such as U.S. Patent Publication No. 2010/0238265 and U.S. Pat. No. 8,520,064, both of which are incorporated herein by reference in their entireties.

In FIG. 11 a window for shared visual content 32 could be positioned below the video window 4. The window for shared visual content 32 could be a PowerPoint presentation that a banking agent could sequence through visuals that would appear on a computer screen at the location of the banking customer. This would allow the agent to present marketing material, such as bank loan rates, car loan programs, mortgage policies, etc. The window for shared visual content 32 could also be used for displaying financial information that would be selected by the agent. In this way the agent could choose the content to be shared in the shared visual content window 32 while retaining a view of the confidential information about the customer in the customer information window 34.

There are innumerable applications for the display of multiple windows on the image display device 3. The experience of a live video communication with eye contact creates a human interaction compared to a computer interaction. The support of computer windows for immediate access to information and the real time display of relevant visual content make it possible to conduct transactions that have financial results. With the addition of a digital signature pad and an integrated printer at the video conference system at the customer location could consummate financial transaction through the live video communication with a live person appearing to be in the room with the customer while making natural eye contact.

FIG. 12 illustrates another arrangement of windows on an image display device 3, which would include a video window in the upper left 4, a user control window on the upper right 33, a customer information window 34 on the lower left and a shared content window 32 on the lower right.

FIG. 13 shows the image display device 3 with a full screen video image 35. In this arrangement there is not a separate window in the position 4. Instead, the person at the other location could be placed in the room to have their eye level positioned at the height and central position to appear at the center of the video window 4 location within the overall video image 35. As an example, the video conference system could be located in the examination room of a doctor's office. A doctor could be the user of an eye-to-eye camera apparatus at their medical center. The image of the doctor would be captured by the eye-to-eye camera apparatus in high definition, which would be transmitted to the exam room for the doctor to appear life-size with eye contact with the patient. The experience for the patient would be a more natural interaction with the doctor as a result of the apparent eye contact. The advantage for the doctor is a high quality video conference system delivering eye contact while not requiring a large amount of physical space within the doctor's office.

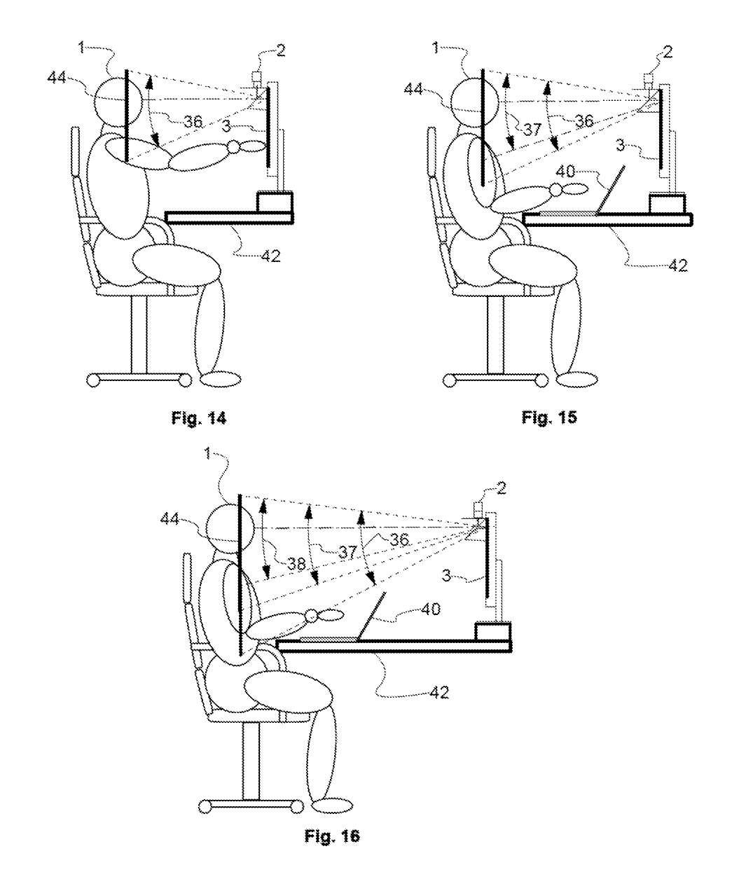

FIG. 14 illustrates an embodiment of the invention with a user 1 and camera 2 with a camera angle of view 36 setting an image plane height 44 within the observation zone at the location of the front of the user 1. The height of the image plane 44 captures a video image of the head and shoulders of the user 1. When this video image of the user 1 is transmitted to the other location to be displayed on a relatively small image display system, such as a 24″ to 32″ monitor, the user could appear to be displayed at lifesize. In this illustration the tabletop 42 is short, which makes it practical to place the eye-to-eye camera assembly and system on any typical desk or table. In this arrangement the user 1 can reach the image display device 3 for the potential of interacting with a touch screen function.

FIG. 15 illustrates the eye-to-eye camera assembly with a camera 2 having a camera angle of view 36 that is the same angle as illustrated in FIG. 14. However, the user 1 is positioned further away from the camera 2. With the greater distance between the camera and the image plane 44 at the front of the user 1 the angle of view 36 captures a larger portion of the body of the user 1. If a fixed focal length lens is used in the camera 2, the camera may only capture the image of the user at the height of the image plane 44. When this video image is transmitted to another location the transmitted user may appear to be displayed at life-size on a medium size monitor, such as a 40″ to 42″ monitor. If it is desired to use the distance between the camera and the image plane as illustrated in this figure to capture the image of the user 1 to appear at life-size on a smaller monitor, it would be necessary to have a lens setting at a longer focal length for a more narrow camera angle of view 37. If the system is to be capable of adjusting the camera angle of view for either a medium angle view or wide angle of view, it will be necessary to have a zoom lens or digital zoom capabilities. In order to maintain the same high definition standard for each view it may be necessary to have an optical zoom, instead of a digital zoom.

In FIG. 15 the distance between the image display device 3 and the user 1 is too great for the user to reach the image display device 3 to use touch screen controls. It may be advantageous to use a keyboard, touch pad, computer and computer screen to perform necessary functions of control and collaboration, such as a laptop 40. In FIG. 15 the distance between the camera 2 and the user 1 will require a tabletop 42 with greater depth than the one illustrated in FIG. 14. This tabletop size may be greater that a standard size desktop.

FIG. 16 shows a greater distance between the camera 2 and the user 1. At this distance the camera angle of view 36 captures an image of the user at the image plane 44 that is high enough to show the user from the waist up. When this video image is transmitted the user may appear to be life-size when display on a larger monitor, such as a 50″ to 60″ monitor. If a camera 2 has a zoom capability the lens can zoom to a longer focal length for a medium angle of view 37 or a longer angle of view 38 to be display on correspondingly smaller screens. It may be possible to send a code from the remote locations to a control system to automatically zoom the lens to the correct focal length for the image of the user 1 to appear life-size on the size of the screen at each location. In this configuration the tabletop 42 is too deep to use a standard desktop and may require placing the eye-to-eye camera apparatus on the direction of the length of the table or specifying a table with a greater width. A laptop 40 could be used in front of the user. However, a larger monitor in front of the user might result in the top of the monitor blocking the lower portion of the widest angle of view 36.

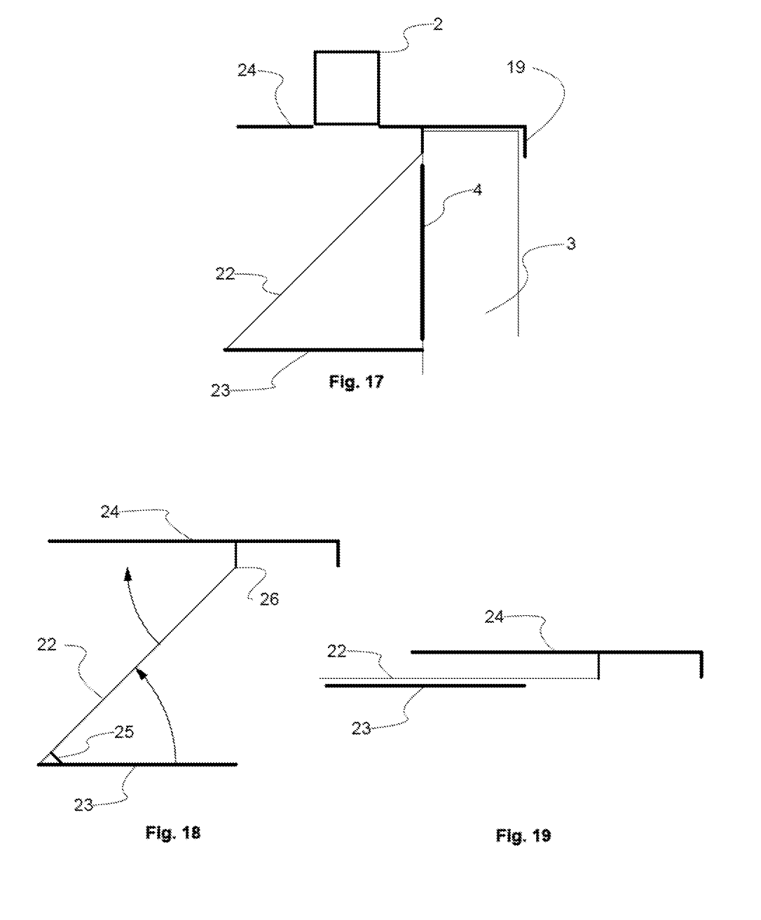

FIG. 17 shows a close-up view of the apparatus. The eye-to-eye camera apparatus is a structure comprised of a camera 2 held in position on a panel 24 that is connected to a two-way mirror 22 and lower panel 23. The assembly is placed on the top of an image display device 3 and held in position by a mounting bracket 19.

FIG. 18 shows the eye-to-eye camera apparatus removed from the image display device. As an optional feature, the lower panel 23 may rotate upward toward the two way mirror 22 at a hinge 25. Also, the two-way mirror may rotate upward toward the upper panel 24 at a hinge 26.

FIG. 19 shows the eye-to-eye camera apparatus folded up with the lower panel 23, the two-way mirror 22 and the upper panel 24 all parallel to each other.

Other variations and modifications will be apparent to one skilled in the art through routine experimentation and are considered and intended to be within the scope of the following claims.

1. An assembly comprising:
a bracket configured to be secured to a display device;
a first panel coupled to the bracket, the first panel comprising an aperture, the first panel being configured to secure a camera to have a camera view through the aperture;
a two-way mirror coupled to the bracket and configured to be positioned below the first panel and angled from the display to reflect the camera view toward an observation zone, the two-way mirror configured to be positioned such that a direct view in the observation zone passes from the display device through the two-way mirror, a width of the two-way mirror being less than a width of a total image area of the display device; and
a second panel coupled to the two-way mirror and configured to be positioned below the two-way mirror opposite the first panel and located in an un-reflected view of the camera view, the width of the two-way mirror being equal to a width of the second panel.

2. The assembly of claim 1, wherein the second panel is a light-absorbing panel.

3. The assembly of claim 1 further comprising the display device, the second panel being located in a plane that intersects the total image area of the display device.

4. The assembly of claim 3, wherein the plane is at an angle in a line-of-sight from the observation zone to a bottom edge of a window area of the total image area.

5. The assembly of claim 1 further comprising the camera secured to the first panel.

6. The assembly of claim 5, wherein the camera comprises a zoom lens to adjust an angle of view of the observation zone.

7. The assembly of claim 1, wherein the first panel, the two-way mirror, and the second panel are collapsible.

8. An assembly comprising:
a display device having a total image area in a display plane, the total image area comprising a window area that is less than the total image area;
a two-way mirror secured to the display device and angled from the display plane, an orthogonal area of the two-way mirror viewed from an observation zone being equal to the window area, the window area being directly viewable through the two-way mirror from the observation zone;
a camera secured to the display device and arranged to view the observation zone by a reflection from the two-way mirror, the camera being disposed above the two-way mirror; and
a light-absorbing panel disposed below the two-way mirror and extending from the two-way mirror to the display plane.

9. The assembly of claim 8, wherein the two-way mirror and the camera are secured to a top of the display device.

10. The assembly of claim 8 further comprising a bracket, the two-way mirror and the camera being secured to the display device by the bracket.

11. The assembly of claim 8, wherein the window area has a window width and a window height, the total image area having an image width and an image height, the window width and window height being less than the image width and image height, respectively.

12. The assembly of claim 8, wherein the light-absorbing panel is in a plane along a direct line-of-sight from the observation zone.

13. The assembly of claim 8, wherein the light-absorbing panel comprises black surface facing the camera.

14. The assembly of claim 8, wherein the camera comprises a zoom lens to adjust an angle of view of the observation zone.

15. A method comprising:
viewing, from an observation zone, a direct view of a window area of a total image area of a display device through a two-way mirror, the two-way mirror being coupled to and angled from the display device, a light-absorbing panel being coupled to and disposed below the two-way mirror and along a plane that intersects the total area of the display device, the window area being less than the total image area of the display device; and
capturing a reflected view of the observation zone by a camera, the camera being coupled to the display device and disposed above the two-way mirror, the reflected view being a reflection from the two-way mirror.

16. The method of claim 15, wherein the two-way mirror and the camera are coupled to a top of the display device.

17. The method of claim 15, wherein the camera and the two-way mirror are coupled to the display device by a bracket.

18. The method of claim 15, wherein the plane is along a line-of-sight from the observation zone to a bottom edge of the window area.

19. The method of claim 15, wherein the window area has a window width and a window height, the total image area having an image width and an image height, the window width and window height being less than the image width and image height, respectively.

20. The method of claim 15, wherein the camera comprises a zoom lens to adjust an angle of view of the observation zone.
